(19) United States
(12) Patent Application Publication
(10) Pub. No.: US 2018/0361561 A1
(43) Pub. Date: Dec. 20, 2018

(54) MOTOR-DRIVEN HAND-HELD TOOL, METHOD FOR USING A HAND-HELD TOOL, COMBINATION OF A MOTOR-DRIVEN HAND-HELD TOOL AND GLOVE

(71) Applicant: GUSTAV KLAUKE GMBH, Remscheid (DE)

(72) Inventor: Egbert Frenken, Heinsberg (DE)

(21) Appl. No.: 16/062,026

(22) PCT Filed: Dec. 14, 2015
(86) PCT No.: PCT/EP2015/079570

§ 371 Date: Jun. 13, 2018

(51) Int. Cl. B25F 5/02; F16P 3/00; A41D 1/00; A41D 19/00; B32B 9/02

(52) U.S. Cl. CPC B25F 5/02; F16P 3/00; A41D 1/002; B32B 2437/02; B32B 9/025; A41D 2600/20; A41D 19/0006

(57) ABSTRACT

A combination of a portable, manually operable motor-driven hand-held tool, such as in particular a cutting or pressing device, and a glove is provided. The hand-held tool has an actuation element, and a user can use the hand-held tool by the glove, wherein the hand-held tool has a sensor configured detect the glove, that the hand-held tool is configured in such a way that a user can only actuate the hand-held tool if the detection of the glove guided to the actuation element has led to a predetermined result, that the sensor is assigned to a handle area of the hand-held tool, and that the distance, at which the glove has to be in order to be detected as being present, is set in such a way that it can be ruled out that the device can be operated with a glove located next to it.

The invention relates to a motor-driven hand-held tool, such as in particular a cutting or pressing device, wherein the hand-held tool has an actuation element, for finger or hand actuation by a user.

The invention furthermore relates to a method for using a motor-driven hand-held tool and furthermore to a combination of a motor-driven hand-held tool and a glove, wherein the user can use the hand-held tool by means of the glove.

The invention further relates to a glove for use with regard to an impacting of an actuation element of a motor-driven hand-held tool.

Such a motor-driven hand-held tool can be a hand-held tool, which is only actuated via an electric motor, for the purpose of which reference is made for example to WO 2014/009 363 A1. It can also be a hydraulic device, however, in the case of which the hydraulic medium is conveyed by means of a pump, which is electrically driven via an electric motor. For this purpose, reference is made for example to WO 99/19947 (US 2001/00027676), to 20 WO 98/24570 (U.S. Pat. No. 6,065,326), to WO 02/62504 (US 2004/0107754) and to WO 02/00368 (US 2002/0148089).

These are, also in the context of the invention, portable, manually operable devices, in particular for cutting, punching or pressing. The devices have a handle and an operating element, preferably configured as operating button, which can be pressed down.

Such hand-held tools are also used to make repairs to power lines or to newly lay power lines. It can happen hereby that such a power line is intentionally voltage-carrying or is inadvertently still voltage-carrying, when carrying out work thereon. This can be a voltage, in particular high voltage, which is, for example, 5 kV or more, for example up to 380 kV.

It is known for this purpose that the user of such a device wears an insulating glove. This can be a leather glove or a rubber or plastic glove, for example. It can happen, however, that such a glove is forgotten or is not used intentionally. In turn, the risk of an accident is then obviously comparatively high.

Based on this, the invention deals with the object of specifying a motor-driven hand-held tool, which guarantees a highest possible safety even when working on voltage-carrying electrical lines. The invention furthermore deals with the object of specifying a method for using such a hand-held tool, which leads to a level of safety, which is as high as possible, in particular when working on a current-carrying electrical conductor. Furthermore with the object of specifying a combination of a motor-driven hand-held tool and a glove, which combination makes it possible to achieve a safety standard, which is as high as possible, in particular with regard to working on current-carrying cables or lines. Last but not least, the invention deals with the object of specifying a glove, which is suitable for safely working with a motor-driven hand-held tool in an advantageous manner.

With regard to the motor-driven hand-held tool, this object is initially solved in that the hand-held tool is configured in such a way that the hand-held tool can only be actuated if a sensor detection of a part guided to the actuation element has led to a predetermined result.

The hand-held tool is thus preferably equipped with a sensor, which allows a startup or carrying out an operational process only if a part comprising a characteristic, which is tailored to the sensor, has been detected. In particular the glove, which has already been mentioned, can be this part.

The sensor detection can be based on a radio detection, for example of a passive radio element, which is located in the glove, as it is known as RFID, for instance. Signals, which are reflected or returned, can then be evaluated according to whether the part is considered to be permissible and whether the operation as a whole or at least the performance of an operational process by means of the motor-driven hand-held tool is to be enabled subsequently.

The hand-held tool can also be equipped with an optical sensor. In this respect, the part, thus in particular the glove, can then have a certain optical marking, for instance in the form of a bar code or the like, or a certain coloring, which, in this case, can also be evaluated in the hand-held tool itself, based on reflected radiation.

The sensor can also be an acoustic sensor. For instance, when the presence of a certain material in the handle area is analyzed by means of ultrasound or other sound signals. The sensor can further also be adapted to suit a magnet. The magnet can hereby be provided in the glove and a so-called Hall sensor or a so-called Reed contact can be provided on the device side, for example for detection.

The sensor is preferably assigned to a handle area of the hand-held tool. It can hereby be arranged in that area, which, when being used, is covered by the hand of a user, which is covered with a glove. However, it can also be arranged in the area of a device part of the hand-held tool located thereabove and can thus be directed to the handle area in such a way that the hand gripping the handle area or the glove located thereabove, respectively, can be detected from the outside.

This thus leads to the embodiment according to the method that the hand-held tool is set in such a way that a user can actuate the hand-held tool only if the detection of the glove by means of a sensor has led to a predetermined result. It can also be provided hereby that the motor-driven hand-held tool as a whole can be adjusted. Thus also to the effect that such an inquiry is not made or, if it is made, respectively, the operation of the hand-held tool is independent on the achieved result. This can be expedient, for instance, if the same motor-driven hand-held tool is used in a different area of application, where a safety with regard to possibly current-carrying electrical conductors is irrelevant.

In detail, the motor-driven hand-held tool can be provided so as to be capable of being re-coded for this purpose, for example. As a result of a special identification, for instance a personal identification number, which has to be input, it can be prevented that the mentioned function is disabled for such applications, which do not depend on the mentioned safety.

With regard to the combination of the motor-driven hand-held tool with the glove, it is provided in a comparable manner that the hand-held tool has a sensor for detecting the glove and that the hand-held tool is configured in such a way that a user can only actuate the hand-held tool if the detection has led to a predetermined result.

In detail, it can also be provided that the glove has features, for instance provided by an RFID, which is mentioned in an exemplary manner, by means of which it is individualized. It can also be prevented with this that the motor-driven hand-held tool of a first person can be operated by means of a glove of a second person, which is configured identical on principle, and vice versa.

It can further also be provided that date information is present in the glove, preferably present in a coded manner, and that the date can in each case be read by means of the sensor. With this, it can be provided for example that gloves, which have exceeded a certain age, regardless of whether the sensor recognizes them as being present, can no longer lead to a startup of the device. Risks resulting from possible wear of the glove (for example holes, which are created), can thus also be prevented.

Last but not least, the use of a glove, which can be detected by means of sensor, in particular of a glove as described in the case at hand, in connection with a motor-driven hand-held tool, which is set up to detect this glove, if work is to be performed by means of the motor-driven hand-held tool on parts, to which electrical voltage is applied, is thus an object of the invention.

The glove can preferably consist of a durable material; at least on the outside, if, as further preferred, the glove is configured of multiple layers. The durable material can be leather, for example. On the inside, the glove can be configured with a second layer, for example of plastic material. The space between the layers can possibly also be used for one of the mentioned elements, RFID element, or the like, in a favorable manner.

The invention will furthermore be described below by means of the enclosed drawing, which, however, only represents an exemplary embodiment.

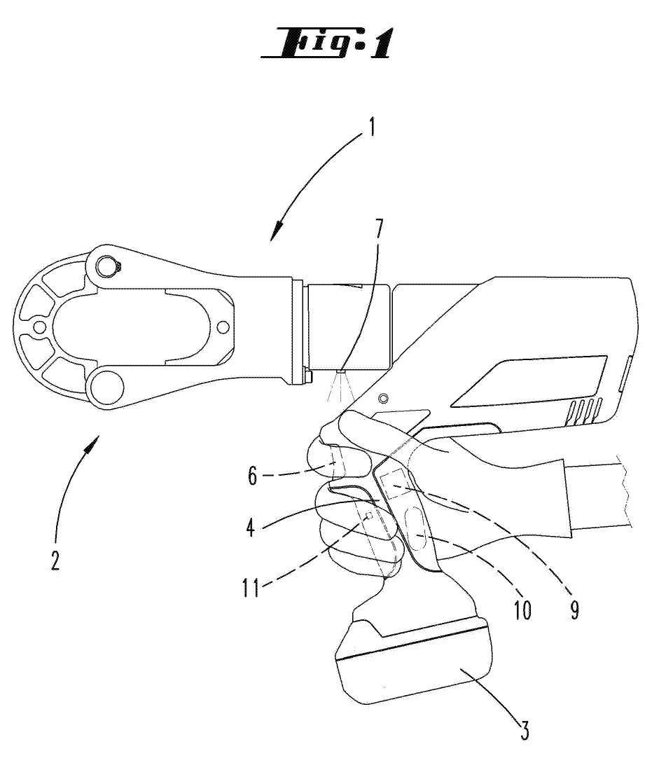

FIG. 1 shows a hydraulically actuated, motor-driven cutting device comprising a glove, which is suggested by the hand of a user and comprises a handle area; and

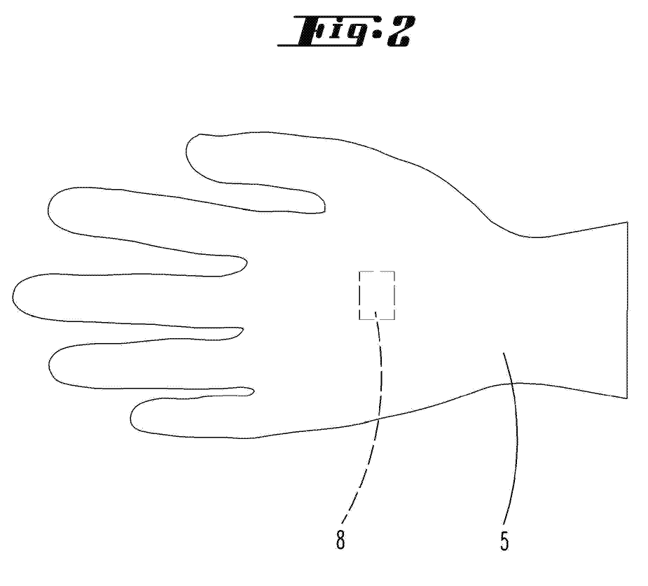

FIG. 2 shows a glove, suitable for use with the device according to FIG. 1, in individual illustration.

With reference to FIG. 1, what is illustrated and described is a motor-driven hand-held tool 1, which, in the case of the exemplary embodiment, has a cutting head 2. In detail, the hand-held tool 1 is driven hydraulically, by means of a pump, which is actuated via an electric motor. An accumulator 3 is provided for the voltage supply of the electric motor.

The hand-held tool 1 further has a handle area 4 and, assigned thereto, an actuation element 6, so that a gripping hand, possibly a hand gloved with a glove 5, can seize this actuation element 6.

The hand-held tool 1 is further equipped with a sensor 7. As suggested in FIG. 1, This sensor can be oriented towards the handle area 4 with regard to its effective direction. However, this is not required in particular in the case of a radio sensor.

As described in more detail with regard to FIG. 2, the glove 5 is provided with an RFID 8 in the exemplary embodiment. The RFID can accordingly be illuminated by the sensor 7 and reflected beams can reflect the coding of the RFID 8, which are then evaluated in the deader, which is assigned to the sensor 7.

Regardless of whether a glove 5 is detected in response to an attempted startup of a hand-held tool 1, the sensor 7 is obviously always supplied with power. The power supply of the pump 9 or of an electric motor 10 as such, however, is only at hand or switched, respectively, if the sensor 7 detects that a glove is present.

It can further be provided hereby that the distance, at which the glove has to be in order to be detected as being present, is comparatively small, is thus approximately in the range of between 5 and 50 cm. In any event, the distance is preferably set in such a way that it can be ruled out that the device can be operated with a glove located next to it.

In more detail, an additional or alternative sensor 11 can also be provided, which can be arranged directly in the handle area. Said sensor can for instance be designed for touch. The sensor 11 located in the handle area can possibly also take over the function of the sensor 7.

The above statements serve to describe the inventions, which are captured as a whole by the application, which further develop the prior art at least by means of the following feature combinations, in each case also independently, namely:

A motor-driven hand-held tool, which is characterized in that the hand-held tool 1 is configured in such a way that the hand-held tool 1 can only be actuated if a sensor detection of a part guided to the actuation element has led to a predetermined result.

A motor-driven hand-held tool, which is characterized in that the hand-held tool 1 is configured for a sensor detection by means of an optical, acoustic, radio, magnetic and/or touch sensor.

A motor-driven hand-held tool, which is characterized in that a sensor 7 is provided for the sensor detection, and that the sensor 7 is assigned to a handle area 4 of the hand-held tool 1.

A method for using a hand-held tool, which is characterized in that the hand-held tool 1 has a sensor 7 for detecting the part, such as for example the glove 5.

A method, which is characterized in that the hand-held tool is set in such a way that a user can actuate the hand-held tool only if the detection has led to a predetermined result.

A combination of a motor-driven hand-held tool and a part, such as a glove, which is characterized in that the hand-held tool 1 has a sensor 7 for detecting the part, and that the hand-held tool 1 is configured in such a way that a user can actuate the hand-held tool 1 only if the detection has led to a predetermined result.

A combination, which is characterized in that the glove 5 is individualized.

A combination, which is characterized in that the predetermined result requires the detection of an individual glove.

A combination, which is characterized in that the glove 5 has date information, which can be detected by the sensor 7, and that the predetermined result requires the detection and evaluation of a permissible date information.

A glove, which is characterized in that the glove 5 is configured with a passive detection element, such as a passive radio element or a shape or color code, wherein the glove is preferably made of a robust material, such as in particular leather material, at least on the outside, and/or that the glove is configured of multiple layers.

### LIST OF REFERENCE NUMERALS

1 hand-held tool
2 cutting head
3 accumulator
4 handle area
5 glove
6 actuation element
7 sensor
8 RFID
9 pump
10 electric motor
11 sensor

1-10. (canceled)

11. A combination of a portable, manually operable motor-driven hand-held tool, such as in particular a cutting or pressing device, and a glove, comprising:
the hand-held tool has an actuation element, and a user can use the hand-held tool by the glove, wherein the hand-held tool has a sensor configured to detect the glove, that the hand-held tool is configured in such a way that a user can only actuate the hand-held tool if the detection of the glove guided to the actuation element has led to a predetermined result, that the sensor is assigned to a handle area of the hand-held tool, and that the distance, at which the glove has to be in order to be detected as being present, is set in such a way that it can be ruled out that the device can be operated with a glove located next to it.

12. The combination according to claim 11, wherein the sensor is an optical, acoustic, radio, magnetic and/or touch sensor.

13. The combination according to claim 11, wherein the glove is individualized.

14. The combination according to claim 13, wherein the glove has date information, which can be detected by the sensor, and that the predetermined result requires the detection and evaluation of permissible date information.

15. The combination according to claim 13, wherein the predetermined result requires the detection of an individual glove.

16. The combination according to claim 15, wherein the glove has date information, which can be detected by the sensor, and that the predetermined result requires the detection and evaluation of permissible date information.

17. A glove configured for use in combination according to claim 11, wherein the glove is configured with a passive detection element, such as a passive radio element or a shape or color code, wherein date information, which can be read by a sensor, is present in the glove.

18. The glove according to claim 17, wherein the glove is formed of multiple layers.

19. The glove according to claim 17, wherein the glove is formed of a robust material, such as in particular leather material, at least on the outside.

20. The glove according to claim 19, wherein the glove is formed of multiple layers.

21. A use of a combination according to claim 1, if work is to be performed by the motor-driven hand-held tool on parts, which carry electrical voltages.
